(19) United States
(12) Patent Application Publication
(10) Pub. No.: US 2026/0289979 A1
(43) Pub. Date: Sep. 24, 2026

(54) VISION LANGUAGE MODELS WITH A HEAD POSE GROUNDING TASK

(71) Applicant: NTT DOCOMO, INC., Tokyo (JP)

(72) Inventors: Yu Tian, Sunnyvale, CA (US); Hsin-Tai Wu, Sunnyvale, CA (US); Tianqi Shao, Sunnyvale, CA (US); Tsukasa Demizu, Sunnyvale, CA (US)

(21) Appl. No.: 19/082,733

(22) Filed: Mar. 18, 2025

(51) Int. Cl. G06V 10/776; G06T 7/73; G06V 10/25; G06V 10/774; G06V 40/10

(52) U.S. Cl. CPC G06V 10/776; G06T 7/73; G06V 10/25; G06V 10/774; G06V 40/10; G06T 2207/20081; G06T 2207/30196

(57) ABSTRACT

Methods and apparatuses for creating and using vision language models (VLMs) that perform head pose estimation (HPE) are disclosed. Some embodiments include a multi-stage process for generating a vision language model (VLM) for head pose estimation (HPE), where the process includes: training of a first vision language model (VLM) on a first set of images to develop capabilities for human head bounding box detection, the first set of images including images of real people; and tuning of the first VLM using a second set of images to generate a second, HPE-oriented VLM, the second set of images being different from the first set of images and including task-specific HPE images. The process also includes performing layer-based merging of a version of the first VLM and the second VLM by selecting entire layers from either to create a layer-based VLM, where the version of the first VLM being the first VLM prior to training on the first set of images, and performing fine-tuning of the layer-based VLM.

### FIELD OF THE DISCLOSURE

Embodiments of the present disclosure are related to vision language models (VLMs); more particularly, embodiments disclosed herein related to integrating head pose estimation (HPE) in a VLM.

### BACKGROUND

HPE is critical in various applications, including driver assistance, human-robot interaction, and customer behavior analysis. Current Convolutional Neural Network (CNN)-based methods like 6DRepNet and WHENet rely on cropped close-up images in which the human head region is initially cropped, often failing in real-world scenarios due to dataset limitations, such as a narrow range of head orientations and uniform backgrounds. Prior VLM-related works like CLIP-Gaze and CLIPose use VLM embeddings for downstream tasks to address pose estimation tasks and rely on external modules or point cloud data, which limit their adaptability.

CogVLM, a state-of-the-art grounding vision-language model, demonstrates robust object localization capabilities by generating bounding boxes (BBox) in the format [[x0, y0, x1, y1]]. This grounding capability allows CogVLM to focus on specific regions of interest within an image, making it highly effective for tasks requiring spatial precision, such as object detection and referring expression comprehension.

### SUMMARY

Methods and apparatuses for creating and using VLMs that perform HPE are disclosed. Some embodiments include a multi-stage process for generating a VLM for HPE, where the process includes: training of a first VLM on a first set of images to develop capabilities for human head bounding box detection, the first set of images including images of real people; and tuning of the first VLM using a second set of images to generate a second, HPE-oriented VLM, the second set of images being different from the first set of images and including task-specific HPE images. The process also includes performing layer-based merging of a version of the first VLM and the second VLM by selecting entire layers from either to create a layer-based VLM, where the version of the first VLM being the first VLM prior to training on the first set of images, and performing fine-tuning of the layer-based VLM.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 shows the prompts and responses designed for HPE Task. It also gives several examples of invalid answers.

FIG. 2A shows some embodiments of a framework for integrating an HPE task into an original grounding CogVLM.

FIG. 2B illustrates a data flow diagram of some embodiments of a multi-stage process for generating a vision language model (VLM) for head pose estimation (HPE).

FIG. 2C illustrates a data flow diagram of some embodiments of a process for performing the layer-based merging based on cosine similarity merging criteria.

FIG. 3 shows a detailed overview of various datasets used in our framework.

FIG. 4 shows the comparison of our HPE-CogVLM performance with various baselines.

FIG. 5 shows the impact of catastrophic forgetting when no data rehearsal is applied.

FIG. 6 shows the mitigation of catastrophic forgetting problem under various rehearsal ratios.

FIG. 7 shows the HPE-oriented CogVLM model exhibits the highest HPE performance within our framework.

FIGS. 8A and 8B show the visualization displays cross attention maps generated in response to our custom prompts.

FIG. 9 represents an example machine-learning architecture used to train a machine-learned model.

FIG. 10 illustrates a block diagram of some embodiments of a computing device.

### DETAILED DESCRIPTION

In the following description, numerous details are set forth to provide a more thorough explanation of the present disclosure. It will be apparent, however, to one skilled in the art, that the present disclosure may be practiced without these specific details. In other instances, well-known structures and devices are shown in block diagram form, rather than in detail, to avoid obscuring the present disclosure.

In some embodiments, a robust framework natively enables vision language models (VLMs) to perform head pose estimation (HPE). In some embodiments, the framework integrates HPE into VLMs, such as, for example, CogVLM, by leveraging their object detection grounding capabilities. The techniques disclosed herein are not limited to the use of CogVLM, and other VLMs can be used.

The direct adaptation of VLMs for HPE tasks presents unique challenges. First, integrating HPE functionality into VLMs often leads to invalid outputs. For example, instead of returning valid formats like a bounding box, referred to herein as BBox, in [[x0, y0, x1, y1]] or HPE as {yaw, pitch, roll}, the models frequently produce mixed formats such as [[x0, y0, yaw angle]]. These blended outputs are unusable and undermine the effectiveness of the model. Second, integrating HPE functionality into VLMs can results in catastrophic forgetting. More specifically, fine-tuning VLMs for HPE tasks frequently results in the loss of previously learned object detection and grounding capabilities, limiting the model's versatility for multimodal tasks. Third, existing merging methods for adapting VLMs, such as direct LoRA fine-tuning or task arithmetic, struggle to balance new task integration with preserving foundational knowledge. These methods either compromise the accuracy of the new HPE task or degrade performance on original tasks, such as visual grounding. Fourth, unlike traditional visual grounding tasks that output 2D bounding boxes, HPE demands precise numerical predictions of 3D Euler angles (yaw, pitch, roll), introducing challenges in achieving both accuracy and consistency.

Embodiments of the framework disclosed herein enhance the precision and robustness of HPE by directly augmenting the VLM (e.g., CogVLM, etc.) to natively perform HPE while, retaining foundational grounding knowledge while significantly improving precision and robustness. This dual enhancement transforms the VLM into a more advanced and versatile tool capable of simultaneous visual grounding and HPE. This approach bridges the gap between conventional HPE methods and modern multimodal frameworks by integrating HPE capabilities directly into the core of the VLM, thereby expanding its functionality and application scope.

In some embodiments, to achieve the integration of HPE into a VLM, a layer-based model merging method is utilized. In some embodiments, the merging is performed using cosine similarity with a high cosine similarity threshold, as well as a “winner-takes-all” layer selection strategy. By employing a high cosine similarity threshold and a “winner-takes-all” layer selection strategy, the model's attention is aligned to the HPE task while its foundational object detection knowledge is preserved. Furthermore, use of these techniques resolves issues with blended invalid response formats and significantly improves accuracy.

Some embodiments utilize one or more of the following features: prompt design, a multi-stage process, layer merging, direct integration beyond embeddings, and the mitigation of catastrophic forgetting.

With respect to prompt design, in some embodiments, the prompts leverage full-image information (as opposed to cropped images) and BBox coordinates to specify human heads of interest in multi-person scenarios. In some embodiments, the use of such prompts facilitates automated inference, reduces manual annotation requirements, and improves task robustness through self-attention and cross-attention mechanisms.

With respect to the multi-stage process, in some embodiments, the stages includes pre-training, fine-tuning, merging, short-term continual fine-tuning and evaluating the model for HPE tasks. Each of these stages is discussed in more detail below. In some embodiments, these stages are designed to address specific challenges, such as ensuring high HPE accuracy, valid output formats and retaining original grounding capabilities. In some embodiments, the multi-stage process uses LoRA-based layer merging that employes a “winner-takes-all” strategy and high cosine similarity thresholds to align the model for new tasks without losing previously acquired knowledge.

In some embodiments, direct integration beyond embeddings is included to enable simultaneous BBox detection and Euler angle prediction for head pose, to avoid relying on any external modules.

Lastly, in some embodiments, the VLM with integrated HPE mitigates the problem of catastrophic forgetting through the use of selected rehearsal ratios during continual fine-tuning to balance old knowledge retention and new grounding task learning.

Each of these features is discussed in greater detail below.

### Prompts Design

In some embodiments, a system that employs the VLM with integrated HPE uses a prompt to enable HPE tasks by leveraging information from full images. In some embodiments, the prompt design utilizes BBox coordinates to specify the human head of interest, particularly in scenarios involving multiple individuals. This design automates the inference process and reduces the need for manual annotations by focusing effectively on specific heads. In some embodiments, the system incorporates global features from self-attention mechanisms and head-specific features from cross-attention mechanisms, enhancing the robustness of HPE tasks.

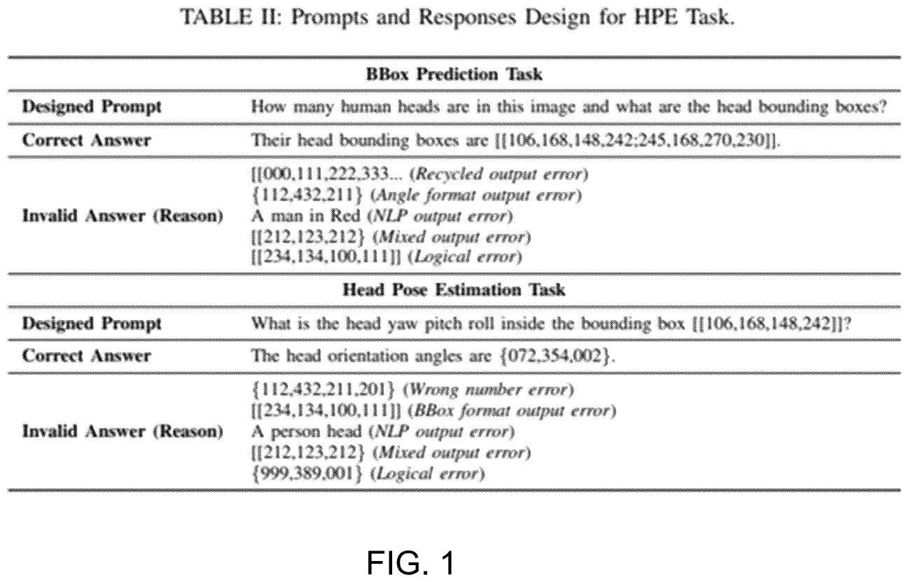

In some embodiments, prompts are structured to allow precise system responses to specific queries. FIG. 1 illustrates examples of such representative prompts and responses for HPE and BBox prediction tasks. Referring to FIG. 1, the prompt includes a designed prompt such as, for example, “How many human heads are in this image and what are the head bounding boxes?” as part of a BBox prediction task and includes a designed prompt such as, for example, “What is the head yaw, pitch and roll inside the bounding box [[106, 168, 148, 242]]?” as part of a head pose estimation task. In some embodiments, BBox formats adhere to the CogVLM specifications, and Euler angle outputs are formatted as positive floats (values), rounded to the nearest integer, and expressed as three-character strings padded with zeros when necessary.

### Framework Overview

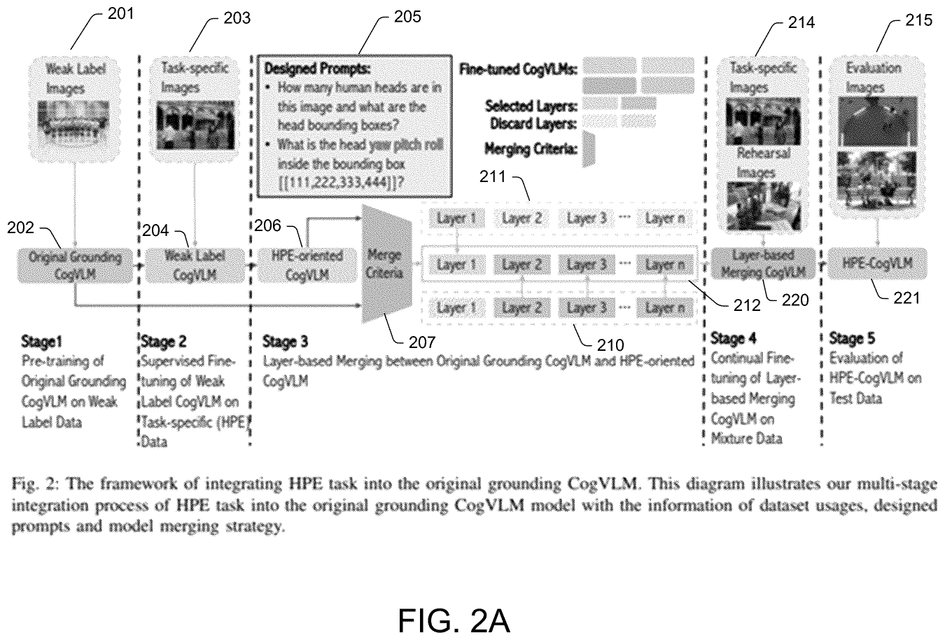

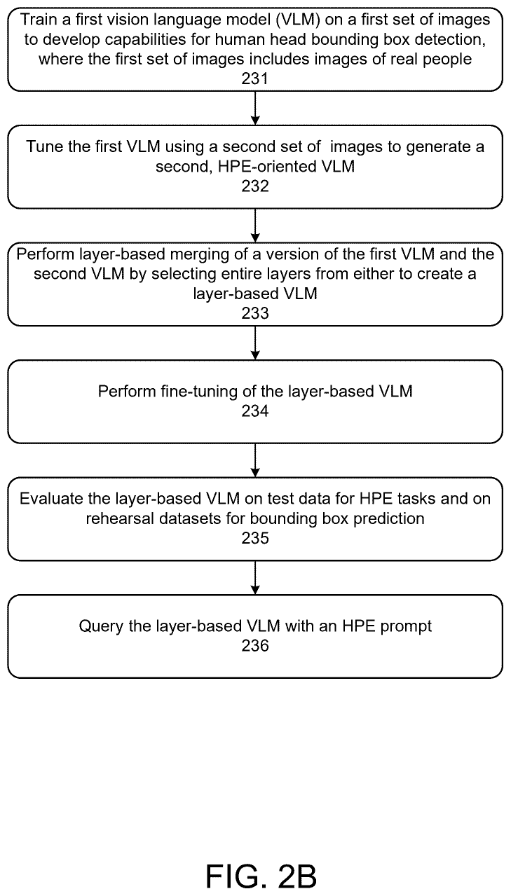

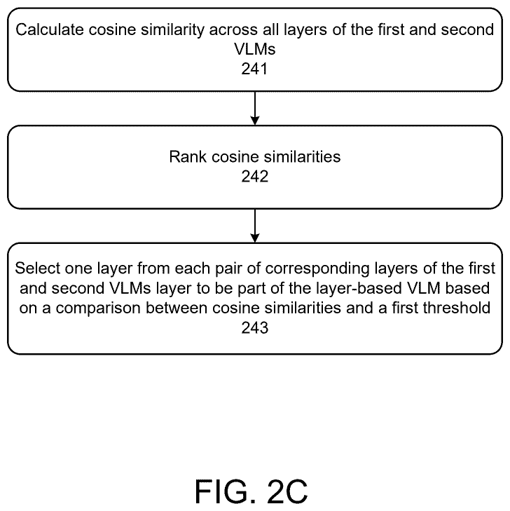

FIG. 2A shows some embodiments of a framework of integrating HPE task into the a VLM. In some embodiments, the multi-stage integration process of HPE task is integrated into the original grounding CogVLM with the information of dataset usages, designed prompts and model merging strategy, to produce a model referred to herein as HPE-CogVLM. Each stage of this framework is designed to enhance different aspects of the model's capabilities, gradually refining the parameters to balance HPE and BBox tasks.

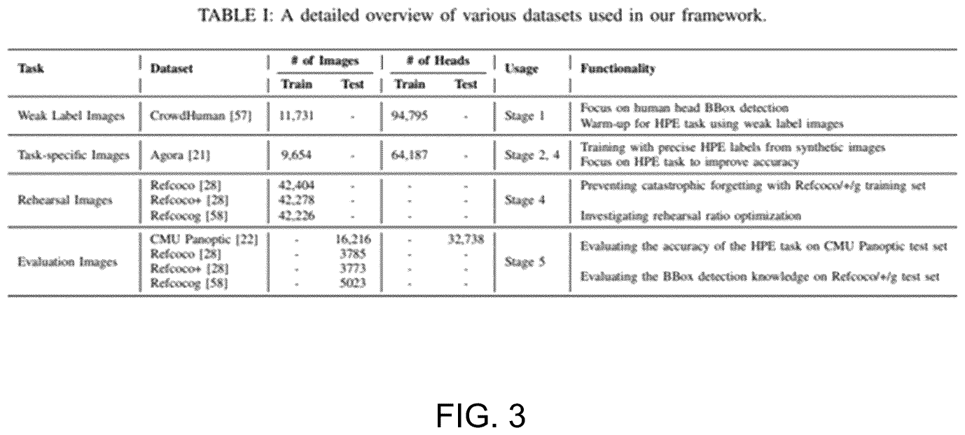

In some embodiments, a fine-tuning process at each stage follows the CogVLM's fine-tuning, which implement LoRA, which is well-known in the art, across transformer blocks, including the query, key, value of attention layers and dense layers. Subsequently, the LoRA matrices of each layer are accumulated into the corresponding layer in the original grounding CogVLM. To support this multi-stage process, the framework utilizes a variety of datasets, each serving a distinct role in model training and evaluation. FIG. 3 provides an overview of how these datasets used in some embodiments to contribute across multiple stages to train and evaluate the model effectively. In some embodiments, the use of such datasets can enhance human head BBox detection, improve HPE task accuracy, and prevent catastrophic forgetting.

Referring to FIG. 2A, the process refines parameters through pre-training, supervised fine-tuning, layer-based merging, continual fine-tuning, and final evaluation stages. The process utilizes specific datasets shown in FIG. 3 strategically across multiple stages to train and evaluate the model effectively.

Stage 1: Pre-training with Weak Label Data

In pre-training stage 1, a VLM model, original grounding CogVLM 202, is trained with weak label images 201 to develop its capability for human head BBox detection. In some embodiments, the weak label images 201 are from the Crowd Human dataset. Additionally, this stage acts as a warm-up for the model's HPE capability by utilizing weak label images. In other words, this pre-training prepares the model to initiate the HPE task in real-world scenarios.

To achieve these goals, in some embodiments, the original grounding CogVLM 202 undergoes pre-training on the CrowdHuman dataset, with pseudo-labels derived from the pre-trained 6DRepNet model, which consists of images of real people in diverse scenes to enable real-world human head detection and to initiate the HPE task. The CrowdHuman dataset offers a rich collection of human head images in various poses and contexts. This approach enables the CogVLM 202 to accurately locate the BBoxes of human heads and establishes a foundational understanding for the subsequent HPE task. However, since the original CrowdHuman dataset provides only accurate head BBox annotations and lacks ground truth (GT) annotations for HPE, the weak HPE annotations can be inferred using 6DRepNet. The output model from this stage is termed as the weak-label CogVLM 204 as shown in FIG. 2.

### Stage 2: Supervised Fine-Tuning on Task-Specific HPE Data

In Stage 2, the weak-label CogVLM 204 undergoes fine-tuning. Following the pre-training stage 201, the weak-label CogVLM 204 progresses to a supervised fine-tuning phase in which the weak-label CogVLM 204 is exclusively trained on task-specific HPE images 203. As shown in FIG. 3, in some embodiments, the fine-tuning in Stage 2 is performed using a synthetic dataset of images. In some embodiments, the synthetic dataset is the Agora dataset as the task-specific images. Unlike the broader CrowdHuman dataset used in Stage 1, the Agora dataset consists of synthetic images that offer more accurate annotations tailored to capture precise head pose information. More specifically, the synthetic Agora dataset provides precise annotations, including the ground truth (GT) for SMPLX parameters and full-range head yaw angles, for fine-tuning HPE tasks. The detailed annotations in the Agora dataset allow the weak-label CogVLM 204 to focus on subtle variations in head orientation, enhancing its ability to make fine-grained predictions.

In some embodiments, Stage 2 focuses on improving the HPE accuracy, addressing the weaknesses in the weak label model's performance due to lower-quality annotations. In some embodiments, the fine-tuning with the synthetic dataset corrects the limitations of weak-label annotations. The output model is referred as the HPE-oriented CogVLM 206 as shown in FIG. 2. This refined HPE-oriented CogVLM 206 combines the real-image exposure and contextual background knowledge gained from Stage 1 with the task-specific precision acquired in Stage 2.

### Stage 3: Layer-Based Merging

During Stage 3, layer-based merging is performed. In some embodiments, during layer-based merging, the original CogVLM 202 is merged with HPE-oriented CogVLM 206 (from Stage 2). In some embodiments, layers of both VLMs are received by merge criteria processing block 207 which selects, based on merge criteria, layers from either or both of the original CogVLM 202 and HPE-oriented CogVLM 206 for inclusion into a layer-based merging CogVLM 220.

In some embodiments, the layer-based merging is performed based on cosine similarity criteria. In this case, cosine similarity is used to gauge the amount of information shared between layers. In some embodiments, cosine similarity is calculated as the average cosine similarity between the layer parameter tensors of the original grounding CogVLM 202 and the HPE-oriented CogVLM 206 along the last dimension.

In some embodiments, a threshold of cosine similarity is used to determine whether layers from the HPE-oriented CogVLM 206 should be integrated into the final, layer-based model (e.g., layer-based merging CogVLM 220). In some embodiments, since LoRA fine-tuning is applied in previous stages, most of the original model parameters are only minimally altered, necessitating a high threshold for cosine similarity. In some embodiments, the threshold is set at 0.95. This can ensure that layers with substantial informational overlap are integrated. In some other embodiments, the threshold is a value greater than 0.9. If the similarity falls below this threshold, the original knowledge is completely retained (e.g., the layer from the original grounding CogVLM 202 is selected for inclusion in the layer-based model that results from the merging (e.g., layer-based merging CogVLM 220). Otherwise, if the similarity exceeds the threshold, which indicates a substantial overlap in information due to the stringent criteria, the entire layer from the HPE-oriented CogVLM 206 is selected for inclusion in the layer-based model to guarantee the minimal risk of losing important existing knowledge.

For example, layers 210 are from the original grounding CogVLM 202 and layers 211 are from HPE-oriented CogVLM 206. As shown Layer 1 from layers 211 of HPE-oriented CogVLM 206 is merged into layer-based merging CogVLM 220 along with Layers 2, 3 and n from layers 210 of the original grounding CogVLM 202. Note that in some embodiments layers in such models include at least one matrix and are well-known in the art.

In some embodiments, the merging criteria for use in some embodiments is detailed as below:
1) Calculate and rank the cosine similarities across all layers from both models, and always select the layer from the original grounding CogVLM 202 within the smallest 1% of cosine similarities, with the ranking being used to identify the smallest 1% of cosine similarities. In some other embodiments, the less than or equal to 5%.
2) When the cosine similarity between two layers from each model is less than the threshold, select the layer from the original grounding CogVLM 202 for inclusion in the layer-based model (e.g., layer-based merging CogVLM 220).
3) Otherwise, select the layer from the HPE-oriented CogVLM 206 for inclusion in the layer-based model (e.g., layer-based merging CogVLM 220).

Thus, a high cosine similarity threshold is used and a “winner-takes-all” method to select entire layers from either the original grounding CogVLM 202 or the HPE-oriented CogVLM 206 to create a layer-based model, Merging CogVLM. This enables the merged model's attention to align with the new HPE task at a reduce, and potentially minimal, cost. Furthermore, the “winner-takes-all” strategy prevents blending errors in output structures and enhances task-specific focus while maintaining robustness. Moreover, by applying a high similarity threshold, layers with minimal similarity are retained from the original grounding CogVLM 202 to preserve foundational knowledge, and new knowledge in introduced only when there is substantial informational overlap between the two models, ensuring that even when a layer is chosen from the HPE-oriented CogVLM 206, existing knowledge remains well-preserved. This approach reduces attention loss while also aligning the model effectively with the new task. Although this new capability introduced in Stage 3 may seem basic, it lays a strong foundation for further refinement, allowing the model to build on this baseline effectively in Stage 4. Additionally, by incorporating entire layers rather than individual parameters, the method preserves the integrity of the model's structure, reducing the risk of response blending when handling multiple grounding tasks with varying requirements.

FIG. 2A also shows designed prompts 205. In some embodiments, designed prompts 205 include for example, “How many human heads are in this image and what are the head bounding boxes?” and “What is the head yaw, pitch and roll inside the bounding box [[111, 222, 333, 444]]?” Stage 4: Continual Fine-tuning on Mixed Data

After merging, the layer-based merging CogVLM 220 undergoes an additional round of fine-tuning with images 214 that include both the task-specific HPE images and the rehearsal images. In some embodiments, the optimal rehearsal ratio for training rehearsal images is pre-defined during Stage 1 by running several parallel experiments. In these experiments, the original grounding CogVLM 202 can tuned with weak label images, each combined with varying proportions of rehearsal images (e.g., 0%,1%,10%,25%), and the rehearsal ratio that yields the best performance is then used to fine-tune the merged model in this stage. In some embodiments, the proportion of rehearsal images used for fine-tuning the layer-based merging CogVLM 220 is 10%. However, the techniques are not limited to using 10%. For example, in some embodiments, other percentages can be used including, but not limited to, those with a range that extends a few percentage points on both sides of 10%.

Unlike the fine-tuning in Stage 2, this phase involves only a brief period of fine-tuning, less than one epoch. The rationale for incorporating additional brief fine-tuning is that while layer merging maintains parameter integrity and optimize model's focus, it lacks the fine-tuned parameters necessary to enhance HPE prediction accuracy. Optimal rehearsal ratios, determined during pre-training, can reduce, and potentially minimize, catastrophic forgetting and improve the model's numerical accuracy. In this manner, the merging model can be quickly fine-tuned to deliver accurate numerical predictions. The final output model of this stage is HPE-CogVLM 221 as shown in FIG. 2A.

In some embodiments, the rehearsal datasets that are used for fine-tuning include the Refcoco, Refcoco+, and Refcocog datasets, used for BBox prediction tasks. The use of these datasets helps mitigate catastrophic forgetting through controlled rehearsal ratios determined by empirical evaluation.

### Stage 5: Evaluation

In Stage 5, the final model, HPE-CogVLM 221, is evaluated on real-world images 215 for HPE tasks and on rehearsal datasets for BBox prediction. In some embodiments, the real-world images are a subset of CMU Panoptic images. The subset of the CMU Panoptic dataset evaluates the model's HPE task performance, reflecting real-world conditions. Rehearsal datasets are used to validate BBox localization capabilities. In some other embodiments, other sets of real-world images or other non-real-world images can be used.

In some embodiments, four evaluation metrics are used for assessing HPE and BBox prediction tasks. These metrics include angle error ratio (E_{angle}), BBox error ratio (E_{bbox}), accuracy (Acc.), and mean absolute error (MAE). Note that in other embodiments, a subset of these metrics are used to evaluate HPE-CogVLM 221. In still other embodiments, additional metrics beyond the four metrics are used to evaluate HPE-CogVLM 221.
1) Angel Error Ratio (E_{angle})—evaluates invalid HPE format predictions. In some embodiments, E_{angle}=e_{angle}/t_{angle}, where e_{angle} denotes the number of invalid HPE answers and t_{angle} denotes the number of total HPE answers. This metric is defined to assess the capability of models to provide relevant numerical outputs for HPE task. When prompted with an HPE query, the CogVLM could produce irrelevant responses such as a natural language processing (NLP) task response like “a person head”, a BBox task response like “[[111,222,333,444]]”, or a blended response like “[[111,999,999,99}” as shown in FIG. 1.
2) BBox Error Ratio (E_{bbox})—evaluates invalid BBox format predictions. In some embodiments, E_{bbox}=e_{bbox}/t_{bbox}, where e_{bbox} denotes the number of invalid BBox answers and t_{bbox} denotes the number of total BBox answers. This metric assesses the capability of models to provide relevant numerical outputs for BBox prediction task.
3) BBox accuracy (ACC.)—measures correct BBox detections with IoU>0.5. In some embodiments, Acc.=m/m\hat{ }, where m denotes the number of valid BBox answers with IoU>0.5 and m\hat{ } denotes the number of total valid BBox answers. A BBox prediction is considered to be accurate if the intersection over union (IoU) between the GT and the prediction exceeds 0.5. The invalid answers are excluded from accuracy and MAE calculation.
4) MAE of Euler angles (MAE)—measures the accuracy of Euler angles. For the HPE task, the MAE between the GT Euler angles and the predicted Euler angles is defined as follows:

$$MAE = \frac{1}{n} {\sum }_{i = 1}^{n} min ( 360 ° - \vert {\hat{A}}_{i} - {A}_{i} \vert , \vert {\hat{A}}_{i} - {A}_{i} \vert )$$

where A\hat{ }ᵢ represents the GT's Euler angles, Aᵢ represents the predicted Euler angles, and variable n denotes the number of valid HPE answers. The MAE is measured in a circular manner rather than linearly, leading to the inclusion of a term that minimizes the difference between the predicted and actual angle by considering a full 360-degree rotation. The MAE value is considered as the average of MAE for yaw, pitch and roll Euler angles.

FIG. 2B illustrates a data flow diagram of some embodiments of a multi-stage process for generating a vision language model (VLM) for head pose estimation (HPE). The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof.

Referring to FIG. 2B, the process includes processing logic training of a first vision language model (VLM) on a first set of images to develop capabilities for human head bounding box detection, the first set of images including images of real people (processing block 231). In some embodiments, the training is considered pre-training of the VLM. In some embodiments, the first VLM is a CogVLM, the first set of images include weak label images, and the second set of images include synthetic images.

After training the first VLM using the first set of images, processing logic tunes the first VLM using a second set of images to generate a second, HPE-oriented VLM (processing block 232). In some embodiments, the second set of images is different from the first set of images and includes task-specific HPE images.

After generating the HPE-oriented VLM, processing logic performs layer-based merging of a version of the first VLM and the second VLM by selecting entire layers from either to create a layer-based VLM (processing block 233). For this operation, in some embodiments, the processing logic uses the version of the first VLM that existed prior to when it was pre-trained on the first set of images. In some embodiments, performing layer-based merging of the first VLM and the second VLM comprises determining an amount of information shared between layers of the first VLM and second VLM and integrating layers with have informational overlap above a first threshold.

In some embodiments, the layer-based merging is based on cosine similarity merging criteria. In some embodiments, the process further includes calculating cosine similarity across all layers of the first and second VLMs as the average cosine similarity between layer parameter tensors of the first VLM and the second VLM. In some embodiments, the process further includes calculating cosine similarity across all layers of the first and second VLMs, ranking cosine similarities for use in selecting the layer from the first VLM (e.g., a layer within the smallest 1% of cosine similarities); and selecting one layer from each pair of corresponding layers of the first and second VLMs layer to be part of the layer-based VLM based on a comparison between cosine similarities and a first threshold. This process is shown in FIG. 2C. In some embodiments, electing one layer from each pair of corresponding layers of the first and second VLMs layer comprises selecting a layer from the first VLM upon determining that the cosine similarity between two corresponding layers of the first and second VLMs is less than the threshold, and selecting the layer from the second VLM upon determining that the cosine similarity between two layers from each model is greater than the threshold.

After creating the layer-based merging VLM, processing logic performs fine-tuning of the layer-based VLM (processing block 234). In some embodiments, performing the fine-tuning of the layer-based VLM is via task-specific HPE images from the second set of images and a set of rehearsal images for BBox prediction.

After fine-tuning the layer-based VLM, processing logic evaluates the layer-based VLM on test data for HPE tasks and on rehearsal datasets for BBox prediction (processing block 235).

In some embodiments, the process also includes querying the layer-based VLM with an HPE prompt (processing block 236). In some embodiments, the querying is performed after fine-tuning of the layer-based VLM. In some embodiments, the HPE prompt comprises full-image information and bounding box coordinates to specify human heads of interest in a multi-person image.

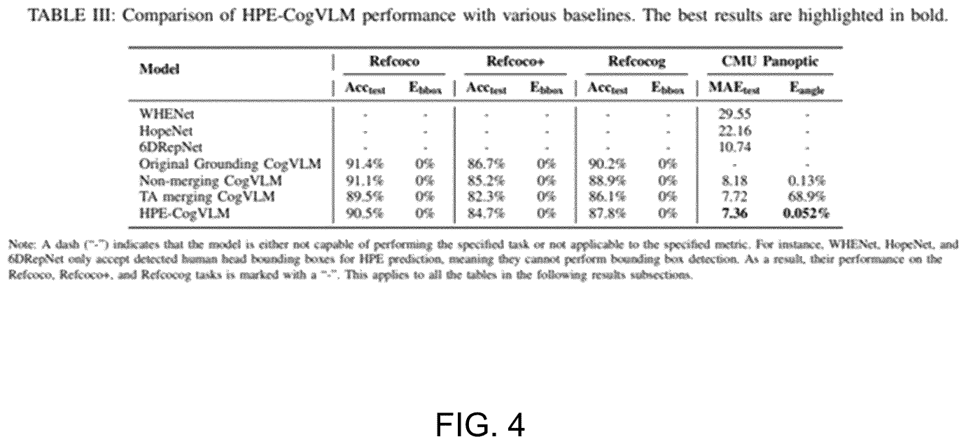

Experimental results demonstrate that the HPE-CogVLM created with the multi-stage process, as evidenced in FIG. 4 demonstrates significant improvements over traditional CNN-based models and alternative VLM-based baselines in HPE tasks and BBox predictions. The HPE-CogVLM exhibits a markedly lower MAE compared to traditional CNN-based models such as WHENet, HopeNet, and 6DRepNet. Specifically, the MAE is reduced by 75.1%, 66.8%, and 31.5%, respectively. These results underline the superior robustness and accuracy of the HPE-CogVLM over CNN-based approaches, which also perform worse than other VLM-based models. This demonstrates the inherent advantages of VLMs in tasks requiring robustness and multimodal grounding. In comparison with Non-merging CogVLM, the HPE-CogVLM achieves a 10% lower MAE compared to a Non-merging CogVLM. Moreover, the invention's E_{angle} is 2.5 times smaller, indicating its enhanced proficiency in HPE tasks. This demonstrates the efficacy of the LoRA layer-based merging method employed by the invention, which significantly improves task-specific performance compared to approaches that do not utilize any model merging techniques. While BBox prediction accuracy of HPE-CogVLM on test datasets is slightly lower than the Non-merging CogVLM by 0.6%, 0.5%, and 1.1%, this outcome is achieved with only ⅕ of the rehearsal image training iterations required by the Non-merging CogVLM. This highlights the efficiency of the HPE-CogVLM in achieving comparable BBox accuracy with significantly fewer computational resources, further reinforcing its practical advantages. In comparison with Task Arithmetic (TA) Merging CogVLM, the HPE-CogVLM outperforms the TA merging CogVLM across all evaluated metrics. Specifically, the BBox prediction accuracy of HPE-CogVLM exceeds that of the TA merging CogVLM by 1%, 2.4%, and 1.7% on the test datasets. For the HPE task, the E_{angle} of the TA merging CogVLM is 68.9%, which is 1,325 times larger than that of the invention, which indicates that only 31.1% of TA merging CogVLM's responses for the HPE task are valid, rendering the MAE metric ineffective for evaluation. These results demonstrate the inability of the TA merging CogVLM to produce relevant numerical responses, even after additional fine-tuning.

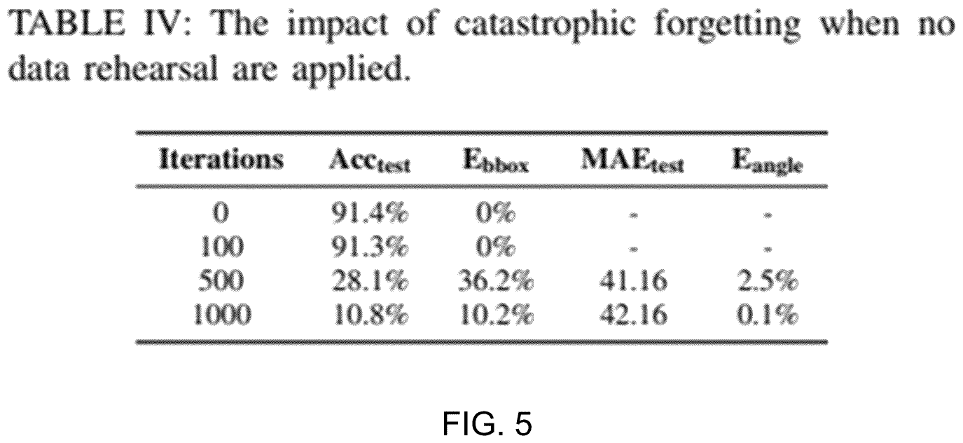

Additionally, with respect to catastrophic forgetting in the HPE Task, the phenomenon of catastrophic forgetting is evident in models trained solely on the HPE task using the Agora dataset. FIG. 5 illustrates the progressive decline in performance for previously acquired tasks, such as object detection, during the adaptation to the new HPE task. The results demonstrate a distinct pattern of catastrophic forgetting: previously acquired knowledge in BBox prediction is substantially diminished before the model solidifies its understanding of the new HPE task. This behavior contrasts with human cognitive processes, where new and old knowledge often coexist and may complement each other. In human learning, integrating new information with existing knowledge is typically achieved without the catastrophic forgetting observed in machine learning models.

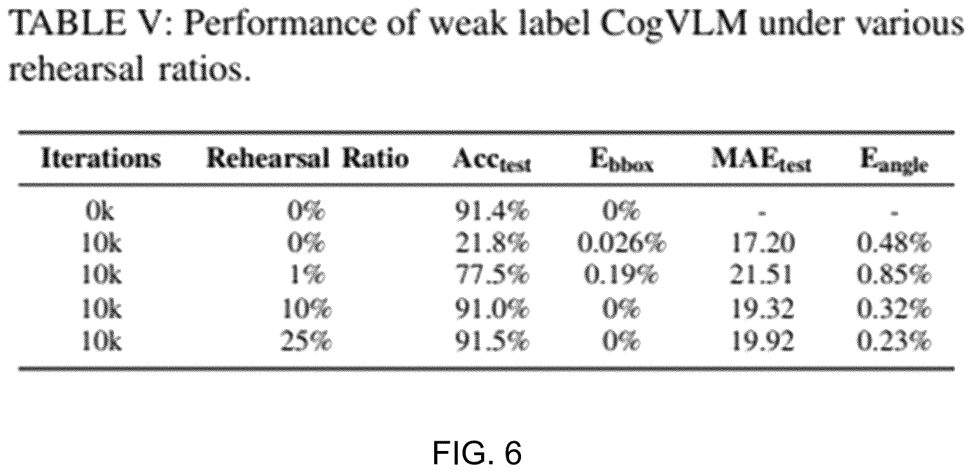

However, in some embodiments, rehearsal ratios are used to mitigate catastrophic forgetting. In some embodiments, a systematic approach is used to determine the optimal rehearsal ratio for mitigating catastrophic forgetting in the BBox prediction task during fine-tuning. FIG. 6 provides a detailed comparison of the weak-label CogVLM's performance at various rehearsal ratios (0%, 1%, 10%, and 25%) during Stage 1 of training. This analysis identifies the most effective ratio for retaining original task knowledge while transitioning to new tasks. In some embodiments, rehearsal ratios of 10% or 25% are selected for Stage 4 fine-tuning experiments. These ratios are significantly higher than the commonly used 1% rehearsal ratio in non-grounding tasks, highlighting the unique requirements of grounding tasks such as BBox prediction and HPE. There is a trade-off between the retention of prior knowledge and the acquisition of new task capabilities. While a higher rehearsal ratio benefits the preservation of existing skills, it does so at the expense of performance on new tasks. Conversely, a lower rehearsal ratio enhances new task performance but may slightly diminish retention of previous knowledge. After evaluating both factors, in some embodiments, the 10% rehearsal ratio as the optimal balance. This ratio achieves significantly better HPE performance, with only a negligible decrease in BBox prediction accuracy compared to the higher ratio. The HPE-CogVLM model trained with the 10% rehearsal ratio is thus selected as the optimal model, effectively balancing the need to retain existing knowledge while enhancing new task performance.

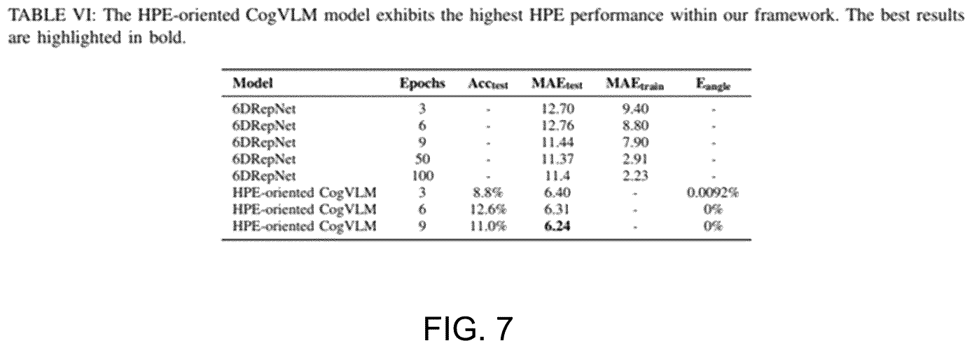

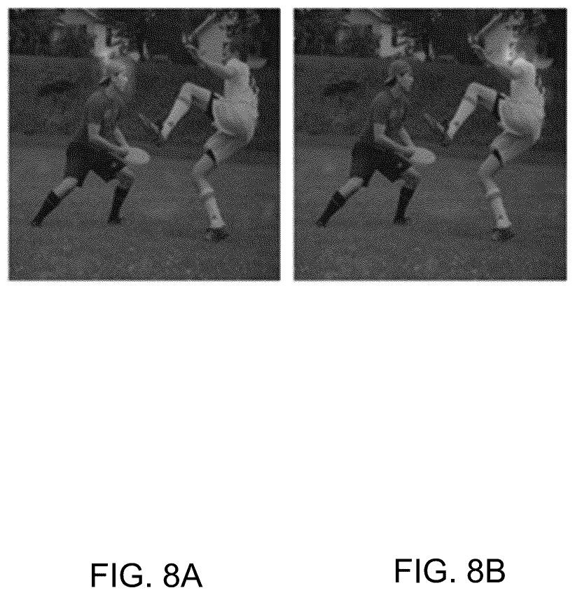

FIG. 7 illustrates the performance of HPE-Oriented CogVLM on HPE task. The HPE-oriented CogVLM, developed in Stage 2 of the framework, is specifically designed for the HPE task, offering optimal performance without accommodating BBox prediction capabilities. Comparative results, presented in FIG. 8, highlight the superior performance of the HPE-oriented CogVLM relative to traditional CNN-based models such as 6DRepNet.

The techniques disclosed herein include a novel approach for visualizing cross-attention maps in response to specifically designed prompts, demonstrating precise localization capabilities within images containing multiple individuals. FIGS. 8A and 8B provide visual evidence of the model's ability to focus its attention based on BBox inputs within the prompts. Referring to FIG. 8A, the attention map associated with the prompt “What is the head yaw pitch roll inside the bounding box (BBox) [[335,179,445,332]]” is shown, and the model's response to a prompt for the HPE task with the specified BBox [[335,179,445,332]] is visualized. The cross-attention map highlights the head of the individual on the left, indicating accurate localization and task-specific focus. Referring to FIG. 8B, similarly, the attention map associated with the prompt “What is the head yaw pitch roll inside the bounding box (BBox) [[775,105,893,261]]” is shown, and the model's response for the prompt specifying the BBox [[775,105,893,261]], such that the model accurately targets the head of the individual. These visualizations validate the model's spatial awareness by confirming its ability to localize attention to specified regions within an image. This capability ensures precise task execution, such as HPE or BBox prediction, even in complex multi-person scenarios.

Furthermore, the techniques disclosed herein demonstrate that CogVLM can effectively process and respond to BBox inputs specified within prompts. It can accurately interpret pre-specified BBoxes provided in the prompts, ensuring robust multimodal grounding for vision-language tasks.

Thus, the techniques disclosed herein provide a number of novel features. First, the techniques include a method for integrating HPE tasks into VLMs through a multi-stage process, including pre-training, supervised fine-tuning, layer-based merging, and short-round continual fine-tuning, applicable to any VLM architecture. Second, the techniques include a model merging technique employing cosine similarity thresholds combined with a winner-takes-all strategy, enabling the integration of task-specific knowledge while preserving foundational capabilities, applicable to merging more than two models. Third, the techniques include the direct integration of HPE into VLMs, going beyond embedding extraction methods, enabling simultaneous object detection and precise head pose estimation. Fourth, the techniques include the mitigation of catastrophic forgetting through optimized rehearsal ratios (10%) during continual fine-tuning for grounding tasks. Fifth, the techniques include a prompt design method leveraging full-image information and BBox coordinates to specify human heads of interest in multi-person scenarios, facilitating automated inference, reducing manual annotation requirements, and improving task robustness through self-attention and cross-attention mechanisms.

The HPE-CogVLM framework and the techniques disclosed herein can be applied in a number of applications. These include, but are not limited to, driver monitoring systems for real-time attention estimation, surveillance systems for crowd behavior analysis, augmented reality and virtual reality systems requiring precise head tracking, advanced robotics for human-robot interaction, and retail environments for customer gaze tracking and behavior analysis. Its modular architecture allows seamless integration with existing systems, enhancing versatility and scalability.

### An Example Machine-Learned Model

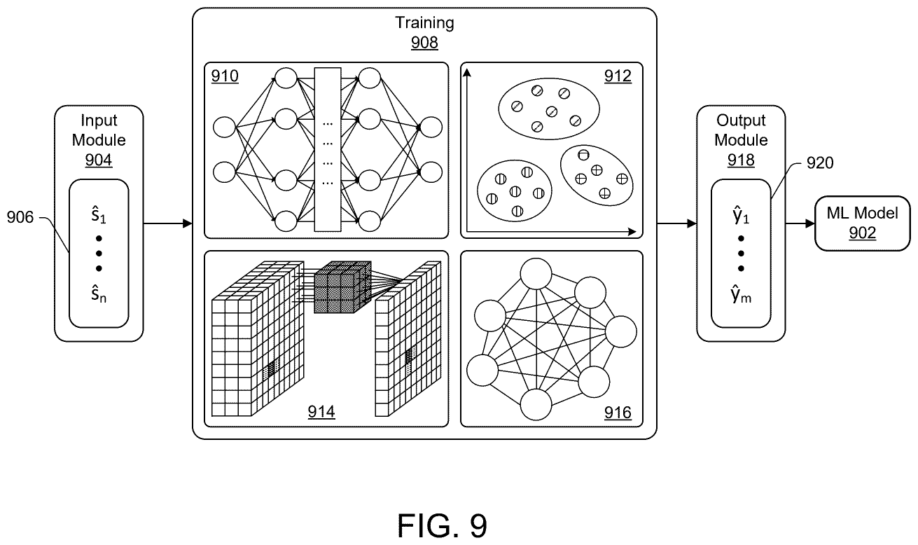

FIG. 9 represents an example machine-learning architecture 900 used to train a machine-learned model 902. An input module 904 accepts an input ŝ 906, which can be an array with members ŝ1 through ŝn. The input s 906 is fed into a training module 908, which processes the input ŝ 906 based on the machine-learning architecture 900. For example, if the machine-learning architecture 900 uses a multilayer perceptron (MLP) model 910, the training module 908 applies weights and biases to the input s 906 through one or more layers of perceptrons, each perceptron performing a fit using its own weights and biases according to its given functional form. MLP weights and biases can be adjusted so that they are optimized against a least mean square, logcosh, or other optimization function (e.g., loss function) known in the art. Although an MLP model 910 is described here as an example, any suitable machine-learning technique can be employed. The training module 908 provides an input to an output module 918. The output module 918 analyzes the input from the training module 908 and provides an output in the form of ŷ 920, which can be an array with members ŷ1 through ŷm. The output 920 can represent a known correlation with the input s 906, such as, for example, object identification, segmentation, and/or classification.

In some embodiments, the input s 906 can be a training input labeled with known output correlation values, and these known values can be used to optimize the output y 920 in training against the optimization/loss function. In other embodiments, the machine-learning architecture 900 can categorize the output ŷ 920 values without being given known correlation values to the inputs ŝ 906. In some embodiments, the machine-learning architecture 900 can be a combination of machine-learning architectures. By way of example, a first network can use the input ŝ 906 and provide the output ŷ 920 as an input ŝML to a second machine-learned architecture, with the second machine-learned architecture providing a final output ŷf. In another embodiment, one or more machine-learning architectures can be implemented at various points throughout the training module 908.

In some machine-learned models, all layers of the model are fully connected. For example, all perceptrons in an MLP model act on every member of s. For an MLP model with a 100×100 pixel image as the input, each perceptron provides weights/biases for 10,000 inputs. With a large, densely layered model, this may result in slower processing and/or issues with vanishing and/or exploding gradients.

### An Example Device

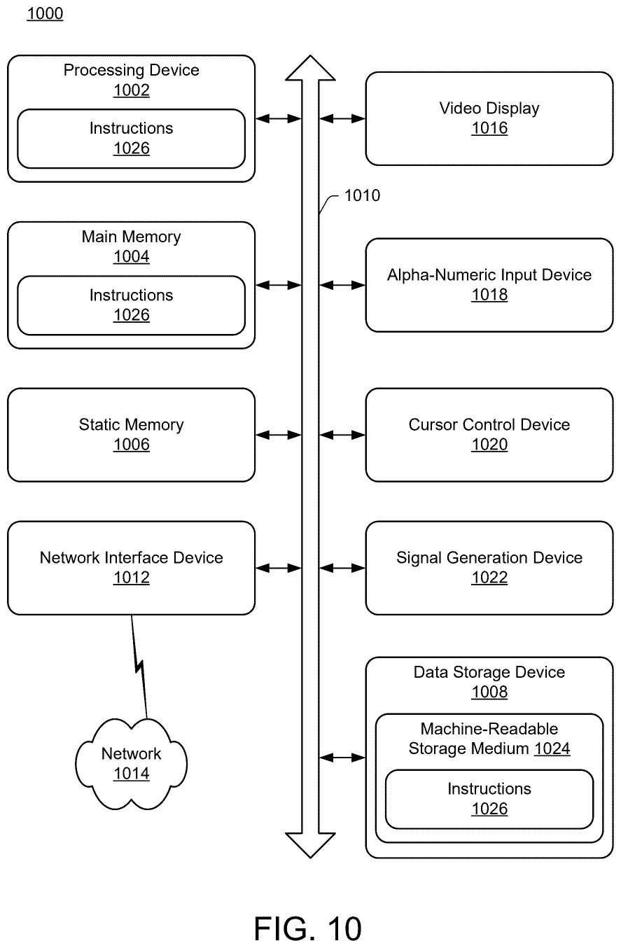

FIG. 10 illustrates a block diagram of some embodiments of a computing device 1000 that can perform one or more of the operations described herein. The computing device 1000 can be connected to other computing devices in a local area network (LAN), an intranet, an extranet, and/or the Internet. The computing device can operate in the capacity of a server machine in a client-server network environment or in the capacity of a client in a peer-to-peer network environment. The computing device can be provided by a personal computer (PC), a server computer, a desktop computer, a laptop computer, a tablet computer, a smartphone, an ultrasound machine, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1000 can include a processing device 1002 (e.g., a general-purpose processor, a programmable logic device (PLD), etc.), a main memory 1004 (e.g., synchronous dynamic random-access memory (DRAM), read-only memory (ROM), etc.), and a static memory 1006 (e.g., flash memory, a data storage device 1008, etc.), which can communicate with each other via a bus 1010. The processing device 1002 can be provided by one or more general-purpose processing devices such as a microprocessor, a central processing unit, or the like. In some embodiments, the processing device 1002 comprises a complex instruction set computing (CISC) microprocessor, a reduced instruction set computing (RISC) microprocessor, a very long instruction word (VLIW) microprocessor, or a processor implementing other instruction sets or processors implementing a combination of instruction sets. The processing device 1002 can also comprise one or more special-purpose processing devices such as an application-specific integrated circuit (ASIC), a field programmable gate array (FPGA), a digital signal processor (DSP), a network processor, or the like. The processing device 1002 can be configured to execute the operations described herein, in accordance with one or more aspects of the present disclosure, for performing the operations and steps discussed herein.

The computing device 1000 can further include a network interface device 1012, which can communicate with a network 1014. The computing device 1000 also can include a video display unit 1016 (e.g., a liquid crystal display (LCD), an organic light-emitting diode (OLED), a cathode ray tube (CRT), etc.), an alphanumeric input device 1018 (e.g., a keyboard), a cursor control device 1020 (e.g., a mouse), and an acoustic signal generation device 1022 (e.g., a speaker, a microphone, etc.). In one embodiment, the video display unit 1016, the alphanumeric input device 1018, and the cursor control device 1020 can be combined into a single component or device (e.g., an LCD touch screen).

The data storage device 1008 can include a computer-readable storage medium 1024 on which can be stored one or more sets of instructions 1026 (e.g., instructions for carrying out the operations described herein, in accordance with one or more aspects of the present disclosure). The instructions 1026 can also reside, completely or at least partially, within the main memory 1004 and/or within the processing device 1002 during execution thereof by the computing device 1000, where the main memory 1004 and the processing device 1002 also constitute computer-readable media. The instructions can further be transmitted or received over the network 1014 via the network interface device 1012.

Various techniques are described in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. In some aspects, the modules described herein are embodied in the data storage device 1008 of the computing device 1000 as executable instructions or code. Although represented as software implementations, the described modules can be implemented as any form of a control application, software application, signal-processing and control module, hardware, or firmware installed on the computing device 1000.

While the computer-readable storage medium 1024 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that causes the machine to perform the methods described herein. The term “computer-readable storage medium” shall accordingly be taken to include, but not be limited to, solid-state memories, optical media, and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the disclosure.

We claim:

1. A multi-stage process for generating a vision language model (VLM) for head pose estimation (HPE), the process comprising:
training of a first vision language model (VLM) on a first set of images to develop capabilities for human head bounding box detection, the first set of images including images of real people;
tuning of the first VLM using a second set of images to generate a second, HPE-oriented VLM, the second set of images being different from the first set of images and including task-specific HPE images;
performing layer-based merging of a version of the first VLM and the second VLM by selecting entire layers from either to create a layer-based VLM, the version of the first VLM being the first VLM prior to training on the first set of images; and
performing fine-tuning of the layer-based VLM.

2. The multi-stage process of claim 1 further comprising querying the layer-based VLM with an HPE prompt.

3. The multi-stage process of claim 2 wherein the HPE prompt comprises full-image information and bounding box coordinates to specify human heads of interest in a multi-person image.

4. The multi-stage process of claim 1 wherein the first VLM is a CogVLM, the first set of images include weak label images, and the second set of images include synthetic images.

5. The multi-stage process of claim 1 wherein performing layer-based merging of the first VLM and the second VLM comprises determining an amount of information shared between layers of the first VLM and second VLM and integrating layers with have informational overlap above a first threshold.

6. The multi-stage process of claim 1 wherein the layer-based merging is based on cosine similarity merging criteria.

7. The multi-stage process of claim 6 further comprising calculating cosine similarity across all layers of the first and second VLMs as the average cosine similarity between layer parameter tensors of the first VLM and the second VLM.

8. The multi-stage process of claim 6 further comprising:
calculating cosine similarity across all layers of the first and second VLMs;
ranking cosine similarities for use in selecting the layer from the first VLM within the smallest 1% of cosine similarities; and
selecting one layer from each pair of corresponding layers of the first and second VLMs layer to be part of the layer-based VLM based on a comparison between cosine similarities and a first threshold.

9. The multi-stage process of claim 8 wherein electing one layer from each pair of corresponding layers of the first and second VLMs layer comprises:
selecting a layer from the first VLM upon determining that the cosine similarity between two corresponding layers of the first and second VLMs is less than the threshold; and
selecting the layer from the second VLM upon determining that the cosine similarity between two layers from each model is greater than the threshold.

10. The multi-stage process of claim 1 wherein performing the fine-tuning of the layer-based VLM is via task-specific HPE images from the second set of images and a set of rehearsal images for bounding box prediction.

11. The multi-stage process of claim 1 further comprising, after fine-tuning the layer-based VLM, evaluating the layer-based VLM on test data for HPE tasks and on rehearsal datasets for bounding box prediction.

12. A system for performing simultaneous object detection and head pose estimation, the system comprising:
an interface for receiving a query with a head pose estimation (HPE) prompt; and
one or more processors coupled to the interface and operable to run an application to perform head pose estimation on the query using a layer-based vision language model (VLM) for head pose estimation (HPE) generated using a multi-stage process that includes:
training of a first vision language model (VLM) on a first set of images to develop capabilities for human head bounding box detection, the first set of images including images of real people, wherein the first set of images include weak label images,
tuning of the first VLM using a second set of images to generate a second, HPE-oriented VLM, the second set of images being different from the first set of images and including task-specific HPE images, wherein the second set of images include synthetic images,
performing layer-based merging of a version of the first VLM and the second VLM by selecting entire layers from either to create the layer-based VLM, the version of the first VLM being the first VLM in a state prior to training on the first set of images, and
performing fine-tuning of the layer-based VLM.

13. The system of claim 12 wherein the first VLM is a CogVLM.

14. The system of claim 12 wherein the HPE prompt comprises full-image information and bounding box coordinates to specify human heads of interest in a multi-person image.

15. The system of claim 12 wherein performing layer-based merging of the first VLM and the second VLM comprises determining an amount of information shared between layers of the first VLM and second VLM and integrating layers which have informational overlap above a first threshold.

16. The system of claim 12 wherein the layer-based merging is based on cosine similarity merging criteria, and the layer-based merging further comprises calculating cosine similarity across all layers of the first and second VLMs as the average cosine similarity between layer parameter tensors of the first VLM and the second VLM.

17. The system of claim 12 wherein the layer-based merging is based on cosine similarity merging criteria, and further comprises:
calculating cosine similarity across all layers of the first and second VLMs;
ranking cosine similarities for use in selecting the layer from the first VLM within the smallest 1% of cosine similarities; and
selecting one layer from each pair of corresponding layers of the first and second VLMs layer to be part of the layer-based VLM based on a comparison between cosine similarities and a first threshold.

18. The system of claim 17 wherein electing one layer from each pair of corresponding layers of the first and second VLMs layer comprises:
selecting a layer from the first VLM upon determining that the cosine similarity between two corresponding layers of the first and second VLMs is less than the threshold; and
selecting the layer from the second VLM upon determining that the cosine similarity between two layers from each model is greater than the threshold.

19. The system of claim 12 wherein performing the fine-tuning of the layer-based VLM is via task-specific HPE images from the second set of images and a set of rehearsal images for bounding box prediction.

20. A non-transitory computer-readable medium having executable instructions to cause one or more processing units to perform head pose estimation (HPE) using a layer-based VLM that is created using a multistage process comprising:
training of a first vision language model (VLM) on a first set of images to develop capabilities for human head bounding box detection, the first set of images including images of real people;
tuning of the first VLM using a second set of images to generate a second, HPE-oriented VLM, the second set of images being different from the first set of images and including task-specific HPE images;
performing layer-based merging of the first VLM and the second VLM by selecting entire layers from either to create a layer-based VLM; and
performing fine-tuning of the layer-based VLM.
